(19) United States
(12) Patent Application Publication
(10) Pub. No.: US 2017/0092938 A1
(43) Pub. Date: Mar. 30, 2017

(54) ELECTRODE MATERIAL FOR LITHIUM-ION RECHARGEABLE BATTERY, ELECTRODE FOR LITHIUM-ION RECHARGEABLE BATTERY AND LITHIUM-ION RECHARGEABLE BATTERY

(71) Applicant: SUMITOMO OSAKA CEMENT CO., LTD., Tokyo (JP)

(72) Inventors: Kouji OONO, Chiba-shi (JP); Hirofumi YASUMIISHI, Yachiyo-shi (JP); Takao KITAGAWA, Funabashi-shi (JP)

(21) Appl. No.: 15/009,312

(22) Filed: Jan. 28, 2016

(30) Foreign Application Priority Data
Sep. 30, 2015 (JP) 2015-193475

(51) Int. Cl. H01M 4/36; H01M 4/62; H01M 4/58; H01M 10/0525

(52) U.S. Cl. CPC H01M 4/366; H01M 10/0525; H01M 4/625; H01M 4/5825; H01M 2004/028

(57) ABSTRACT

An electrode material tor a lithium-ion rechargeable battery of the present invention includes inorganic particles represented by General Formula LiFeₓMn_{1-x-y}M_{y}PO₄ (0.05≦x≦1.0, 0≦y≦0.14; here, M represents at least one element selected from Mg, Ca, Co, Sr, Ba, Ti, Zn, B, Al, Ga, In, Si, Ge, and rare earth elements) and a carbonaceous film coating surfaces of the inorganic particles, and at least one peak of a micropore diameter distribution is present in a range of 0.4 nm to 5.0 nm. An electrode for a lithium-ion rechargeable battery of the present invention includes the electrode material for a lithium-ion rechargeable battery of the present invention. A lithium-ion rechargeable battery of the present invention includes a cathode, an anode, and a non-aqueous electrolyte, in which the electrode for a lithium-ion rechargeable battery of the present invention is used as the cathode.

### BACKGROUND OF THE INVENTION

Field of the Invention

The present invention relates to an electrode material for a lithium-ion rechargeable battery, an electrode for a lithium-ion rechargeable battery, and a lithium-ion rechargeable battery.

Description of Related Art

In recent years, as a battery anticipated to have a small size, a light weight, and high capacity, a non-aqueous electrolytic solution-based rechargeable battery such as a lithium-ion rechargeable battery has been proposed and put into practical use.

The lithium-ion rechargeable battery is constituted with a cathode and an anode which have properties capable of reversibly intercalating and deintercalating lithium ions, and a non-aqueous electrolyte.

As an anode material for a lithium-ion rechargeable battery, generally, a Li-containing metal oxide having properties capable of reversibly intercalating and deintercalating lithium ions such as lithium titanate (Li₄Ti₅O₁₂) or a carbon-based material is used.

On the other hand, as a cathode material for a lithium-ion rechargeable battery, an electrode material mixture including a Li-containing metal oxide having properties capable of reversibly intercalating and deintercalating lithium ions such as lithium iron phosphate (LiFePO₄), a binder, and the like is used. In addition, a cathode of a lithium-ion rechargeable battery is formed by applying this electrode material mixture to the surface of a metal foil called a current collector.

Compared with rechargeable batteries of the related art such as lead batteries, nickel-cadmium batteries, and nickel metal hydride rechargeable batteries, the lithium-ion rechargeable batteries have a lighter weight, a smaller size, and higher energy. Therefore, the lithium-ion rechargeable batteries are used not only as a small-size power supply used in portable electronic devices such as mobile phones and notebook personal computers but also as a large-size stationary emergency power supply.

In addition, recently, studies have been underway to use lithium-ion rechargeable batteries as a high-output power supply for plug-in hybrid vehicles, hybrid vehicles, electric power tools, and the like. For batteries used as the above-described high-output power supply, there is a demand for high-speed charge and discharge characteristics.

However, an electrode material including a lithium phosphate compound having properties capable of reversibly intercalating and deintercalating lithium ions has a problem with low electron conductivity. As an electrode material for solving the above-described problem, for example, the electrode material described in Japanese Laid-open Patent Publication No. 2001-15111 is known as a related art. In Japanese Laid-open Patent Publication No. 2001-15111, in order to increase the electron conductivity of an electrode material, the surfaces of particles of an electrode active material for an electrode material are coated with an organic compound which is a carbon source. After that, the organic compound is carbonized, whereby a carbonaceous film is formed on the surface of the electrode active material, and an electrode material in which carbon in this conductive carbonaceous film is interposed as an electron conductive substance is obtained.

### SUMMARY OF THE INVENTION

Meanwhile, in order to use the electrode active material including a lithium phosphate compound as an electrode material for a lithium-ion rechargeable battery used as a high-output power supply, there is a demand for electron conductivity being increased by forming a carbonaceous film on the surface of the electrode active material.

However, the presence of the carbonaceous film causes migration of lithium ions in an interface between the electrode active material and the carbonaceous film, and there is a problem of a low migration rate. Therefore, when the area of the surface of the electrode active material coated with the carbonaceous film is increased in order to improve electron conductivity, the migration rate of lithium ions is also decreased. Therefore, improvement of electron conductivity and improvement of lithium ion conductivity has a trade-off relationship with each other. As a result, in an electrode active material coated with a carbonaceous film more than necessary, even when electron conductivity is improved, the battery internal resistance increases, and particularly, voltage significantly drops when high-speed charging and discharging is carried out.

The present invention has been made in order to solve the above-described problem, and an object of the present invention is to provide an electrode material having favorable lithium ion conductivity even when the coating ratio of inorganic particles with a carbonaceous film is high, an electrode including the same electrode material, and a lithium-ion rechargeable battery including the same electrode.

In the present invention, the reaction rate of lithium ions entering and exiting an electrode active material is evaluated using activation energy. Meanwhile, the activation energy has a relationship of the following equation with the reaction rate.

k=k0×exp(G*/RT)

(k: reaction rate, k0: reaction rate in a standard state, G*: activation energy, T: temperature, R: gas constant)

The present inventors and the like carried out intensive studies in order to solve the above-described problem and consequently found that, when the micropore diameter distribution of an electrode material is controlled so as to have a peak of the micropore diameter distribution in a range of 0.4 nm to 5.0 nm, it is possible to achieve favorable lithium ion conductivity even when the coating ratio of inorganic particles with a carbonaceous film is high. That is, the present invention is as described below.

[1] An electrode material for a lithium-ion rechargeable battery including inorganic particles represented by General Formula LiFeₓMn_{1-x-y}M_{y}PO₄ (0.05≦x≦1.0, 0≦y≦0.14; here, M represents at least one element selected from Mg, Ca, Co, Sr, Ba, Ti, Zn, B, Al, Ga, In, Si, Ge, and rare earth elements) and a carbonaceous film coating surfaces of the inorganic particles, in which at least one peak of a micropore diameter distribution is present in a range of 0.4 nm to 5.0 nm.

[2] The electrode material for a lithium-ion rechargeable battery according to [1], in which two or more peaks of a micropore diameter distribution are present in a range of 0.4 nm to 5.0 nm.

The electrode material for a lithium-ion rechargeable battery according to [1] or [2], in which activation energy for a migration reaction of lithium ions in an interface between the inorganic particle and the carbonaceous film is 70 kJ/mol or less.

[4] The electrode material for a lithium-ion rechargeable battery according to any one of [1] to [3], in which the carbonaceous film coats 50% or more of the surfaces of the inorganic particles.

[5] An electrode for a lithium-ion rechargeable battery-including the electrode material for a lithium-ion rechargeable battery according to any one of [1] to [4].

[6] A lithium-ion rechargeable battery including a cathode, an anode, and a non-aqueous electrolyte, in which the electrode for a lithium-ion rechargeable battery according to [5] is used as the cathode.

According to the present invention, it is possible to provide an electrode material having favorable lithium ion conductivity even when the coating ratio of inorganic particles with a carbonaceous film is high, an electrode including the same electrode material, and a lithium-ion rechargeable battery including the same electrode.

### DETAILED DESCRIPTION OF THE INVENTION

Hereinafter, the present invention will be described, but the present invention is not limited to the following embodiment.

### Electrode Material for Lithium-ion Rechargeable Battery

An electrode material for a lithium-ion rechargeable battery of the present invention thereinafter, simply referred to as the electrode material) includes inorganic particles represented by General Formula LiFeₓMn_{1-x-y}M_{y}PO₄ (0.05≦x≦1.0, 0≦y≦0.14; here, M represents at least one element selected from Mg, Ca, Co, Sr, Ba, Ti, Zn, B, Al, Ga, In, Si, Ge, and rare earth elements) and a carbonaceous film coating surfaces of the inorganic particles and has at least one peak of a micropore diameter distribution in a range of 0.4 nm to 5.0 nm. Therefore, it is possible to make lithium ions rapidly migrate in an interface between the inorganic particles and the carbonaceous film and achieve favorable lithium ion conductivity even when the coating ratio of the inorganic particles with the carbonaceous film is high. In addition, it becomes possible to satisfy both the supply of high-speed electrons to a reaction point and the high-speed migration of lithium ions, and an electrode material satisfying high-speed charge and discharge characteristics can be realized. Meanwhile, the electrode material needs to have at least one peak of the micropore diameter distribution in a range of 0.4 nm to 5.0 nm as described above. Therefore, the electrode material may have one or more peaks of the micropore diameter distribution in a range of 0.4 nm to 5.0 nm.

Here, the micropore diameter distribution refers to the distribution of micropore diameters on the surface of the electrode material measured using a device described below.

### Inorganic Particles

The inorganic particles used in the electrode material of the present invention are inorganic particles represented by General Formula LiFeₓMn_{1-x-y}M_{y}PO₄ (0.05≦x≦1.0, 0≦y≦0.14; here, M represents at least one element selected from Mg, Ca, Co, Sr, Ba, Ti, Zn, B, Al, Ga, In, Si, Ge, and rare earth elements). Meanwhile, the rare earth elements refer to 15 elements of La, Ce, Pr, Nd, Pm, Sm, Eu, Gd, Tb, Dy, Ho, Er, Tm, Y, and Lu which belong to the lanthanum series. In addition, the inorganic particles used in the electrode material of the present invention may be inorganic particles of one compound represented by General Formula LiFeₓMn_{1-x-y}M_{y}PO₄ or a mixture of two or more kinds of inorganic particles.

The specific surface area of the inorganic particles is preferably in a range of 5 m²/g to 20 m²/g and more preferably in a range of 9 m²/g to 13 m²/g. When the specific surface area of the inorganic particles is 5 m²/g or more, it is possible to achieve favorable output characteristics of a lithium-ion rechargeable battery by shortening the time period taken for lithium ions and electrons to migrate among the inorganic particles. When the specific surface area of the inorganic particles is 20 m²/g or less, an increase in the weight of the carbonaceous film caused by an increase in the specific surface area of the inorganic particles is suppressed, and the charge and discharge capacity can be increased.

### Carbonaceous Film

The carbonaceous film coats the surfaces of the inorganic particles and improves the electron conductivity of the electrode material. The coating ratio with the carbonaceous film is preferably 50% or more and more preferably 70% or more. When the coating ratio of the carbonaceous film is 50% or more, the supply of electrons from the carbonaceous film becomes favorable, and an intercalating and deintercalating reaction of lithium ions at a reaction point on the surface of the inorganic particle becomes fast, whereby output characteristics are also improved.

The coating ratio with the carbonaceous film can be measured using a transmission election microscope (TEM), an energy-dispersive X-ray spectrometer (EDX), or the like as described below.

The proportion of the mass of the carbonaceous film in the mass of the inorganic particles is preferably in a range of 0.5% by weight to 5% by weight and more preferably in a range of 0.8% by weight to 3% by weight. When the proportion of the carbonaceous weight is 0.5% by weight or more, it is possible to improve the electron conductivity of the electrode material, and high output characteristics can be made to be favorable. When the proportion of the carbonaceous weight is 5% by weight or less, it is possible to suppress the charge and discharge capacity being decreased due to an increase in the carbonaceous film not contributing to improvement of electron conductivity.

The average film thickness of the carbonaceous film is preferably in a range of 0.1 nm to 5.0 nm and more preferably in a range of 1.0 nm to 5.0 nm. When the average film thickness of the carbonaceous film is 0.1 nm or more, it is possible to sufficiently ensure the electron conductivity of the electrode material, consequently, the internal resistance of the battery is decreased, and voltage drop at a high charge-discharge rate can be suppressed. When the average film thickness of the carbonaceous film is 5.0 nm or less, a distance of lithium ions migrating in the carbonaceous film in which the diffusion rate of lithium ions is slow becomes short, and voltage drop at a high charge-discharge rate can be suppressed.

Meanwhile, the “internal resistance” mentioned herein refers to the sum of mainly electron migration resistance and lithium ion migration resistance. Regarding the internal resistance, the electron migration resistance is proportional to the film thickness of the carbonaceous film and the density and crystallinity of the carbonaceous film, and the lithium ion migration resistance is inversely proportional to the film thickness of the carbonaceous film and the density and crystallinity of the carbonaceous film.

As a method for evaluating the internal resistance, it is possible to use, for example, an electric current-rest-method or the like. In the electric current-rest-method, the internal resistance is measured as the sum of an interconnection resistance, a contact resistance, a charge migration resistance, a lithium ion migration resistance, a lithium reaction resistance in the positive electrode and the negative electrode, an interelectrode resistance determined depending on the distance between the positive electrode and the negative electrode, solvation of lithium ions, a resistance relating to desolvation, and a solid electrolyte interface (SEI) migration resistance of lithium ions.

### Activation Energy

The activation energy for a migration reaction of lithium ions in the interface between the inorganic particle and the carbonaceous film is preferably 70 kJ/mol or less, more preferably 60 kJ/mol or less, and still more preferably 50 kJ/mol or less. When the activation energy is 70 kJ/mol or less, migration of lithium ions in the interface between the inorganic particle and the carbonaceous film becomes fast. Therefore, the lithium ion conductivity of the electrode material becomes favorable in spite of the carbonaceous film being coated with the inorganic particles.

### Method for Manufacturing Electrode Material

In a method for manufacturing an electrode material of the present invention, a slurry including the inorganic particles or a precursor thereof, an organic compound as a carbonaceous film precursor, and water is produced and dried, thereby manufacturing a dried substance. Next, the obtained dried substance is calcinated at a temperature in a range of 500° C. to 1000° C. in a non-oxidative atmosphere, thereby manufacturing an electrode material.

In order to provide a desired micropore diameter distribution to the electrode material, the electrode material is generated by calcinating a slurry dried in an atmosphere including a small amount of oxygen, using a carbon source organic substance including a large amount of oxygen in the structure as the carbonaceous film precursor, or mixing a template substance that does not remain as the carbonaceous film in.

The inorganic par tides used in the method for manufacturing an electrode material are, similar to the inorganic particles described in the section of the electrode material, inorganic particles represented by General Formula LiFeₓMn_{1-x-y}M_{y}PO₄ (0.05≦x≦1.0, 0≦y≦0.14; here, M represents at least one element selected from Mg, Ca, Co, Sr, Ba, Ti, Zn, B, Al, Ga, In, Si, Ge, and rare earth elements). As the inorganic particles represented by General Formula LiFeₓMn_{1-x-y}M_{y}PO₄, it is possible to use inorganic particles manufactured using a method of the related art such as a solid phase method, a liquid phase method, or a gas phase method.

For example, a Li source selected from a group consisting of lithium salts such as lithium acetate (LiCH₃COO) and lithium chloride (LiCl) and lithium hydroxide (LiOH), a divalent iron salt such as iron (II) chloride (FeCl₂), iron (II) acetate (Fe(CH₃COO)₂), andiron (II) sulfate (FeSO₄), a phosphate compound such as phosphoric acid (H₃PO₄), ammonium dihydrogen phosphate (NH₄H₂PO₄), and diammonium hydrogen phosphate ((NH₄)₂HPO₄), and water are mixed together, thereby manufacturing a slurry-form mixture. In addition, the obtained mixture is hydrothermally synthesized using a pressure-resistant airtight container, thereby manufacturing a precipitate. Next, the obtained precipitate is washed with water, thereby producing cake-form inorganic particles. This compound (LiFeₓMn_{1-x-y}M_{y}PO₄ powder) can be preferably used as the inorganic particles used in the method for manufacturing an electrode material.

The LiFeₓMn_{1-x-y}M_{y}PO₄ powder may be crystal particles, amorphous particles, or mixed crystal particles in which crystal particles and amorphous particles coexist. Here, the reason why the LiFeₓMn_{1-x-y}M_{y}PO₄ powder may be amorphous particles is that, when thermally treated at a temperature in a range of 500° C. to 1000° C. in a non-oxidative atmosphere, the amorphous LiFeₓMn_{1-x-y}M_{y}PO₄ powder is crystallized.

The average particle diameter of primary particles of the inorganic particles used in the method for manufacturing an electrode material is not particularly limited, but is preferably in a range of 0.01 μm to 20 μm and more preferably in a range of 0.02μm to 5 μm. When the average particle diameter of the primary particles of the inorganic particles is 0.01 μm or more, it becomes possible to sufficiently coat the surfaces of the inorganic particles with a carbon thin film. Therefore, the discharge capacity being decreased at a high charge-discharge rate can be suppressed, and it becomes possible to realize sufficient charge and discharge rate performance. When the average particle diameter of the primary particles of the inorganic particles is 20 μm or less, the internal resistance of the primary particles becomes great. Therefore, it is possible to sufficiently increase the discharge capacity at a high charge-discharge rate.

The shape of the inorganic particle used in the method for manufacturing an electrode material is not particularly limited, but is preferably a spherical shape, particularly, a truly spherical shape since it is easy to generate an electrode material made of spherical secondary particles, particularly, truly spherical secondary particles.

Here, the reason for the shape of the inorganic particle being preferably a spherical shape is that it is possible to decrease the amount of a solvent when a cathode paste is prepared by mixing the inorganic particles, a binder resin (binding agent), and a solvent. In addition, another reason for the shape of the inorganic particle being preferably a spherical shape is that it becomes easy to apply the cathode paste to a current collector.

In addition, when the shape of the inorganic particle is a spherical shape, the surface area of the inorganic particles is minimized, it is possible to minimize the blending amount of the binder resin (binding agent) added to the electrode material mixture, and the internal resistance of a cathode to be obtained can be decreased. Therefore, the shape of the inorganic particle is preferably a spherical shape.

Furthermore, when the shape of the inorganic particle is a spherical shape, it is easy to closely pack the inorganic particles, and thus the amount of the electrode material packed per unit volume becomes great, and it is possible to increase the electrode density. As a result, it is possible to increase the capacity of a lithium-ion rechargeable battery.

Examples of the organic compound used as the carbonaceous film precursor include polyvinyl alcohols, polyvinylpyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, divalent alcohols, trivalent alcohols, and, the like. These organic compounds may be used singly or in a mixture form of two or more organic compounds.

Examples of the carbon source organic substance including a large amount of oxygen in the structure which is used as the carbonaceous film precursor include modified polymers such as polyoxyethylene succinic acid esters and polyoxyethylene/polyoxypropylene, polyoxyethylene sorbitan esters, and the like. These carbon source organic substances may be used singly or in a mixture form of two or more carbon sources organic substances. In addition, a carbon source organic substance including a large amount of oxygen in the structure generated by means of dehydration caused by a condensation reaction in the above-described step may be used as the carbonaceous film precursor.

Examples of the template substance that does not remain as the carbonaceous film include glycol-based oligomers such as low-molecular-weight wax emulsions and diethylene glycol, low-molecular-weight paraffin emulsions, and the like. These template substances may be used singly or in a mixture form of two or more template substances.

In order to make the electrode material have at least one peak of the micropore diameter distribution in a range of 0.4 nm to 5.0 nm, the content of the template substance for forming micropores in the carbonaceous film is preferably in a range of 10 parts by mass to 100 parts by mass and more preferably in a range of 25 parts by mass to 50 parts by mass with respect to 100 parts by mass of the organic compound used as the carbonaceous film precursor.

The blending ratio of the organic compound to the inorganic particles is preferably in a range of 0.5 parts by mass to 5.0 parts by mass with respect to 100 parts by mass of the inorganic particles when the total amount of the organic compound is converted to the amount of carbon.

Here, when the blending ratio of the organic compound in terms of the amount of carbon is 0.5 parts by mass or more, the discharge capacity at a high charge-discharge rate becomes high in a case in which a rechargeable battery is formed, and sufficient charge and discharge rate performance can be realized. When the blending ratio of the organic compound in terms of the amount of carbon is 5.0 parts by mass or less, it is possible to set the average film thickness of the carbonaceous film to 5 nm or less.

The inorganic particles and the organic compound are dissolved or dispersed in water, thereby preparing a homogeneous slurry. During the dissolution or dispersion, a dispersing agent may be added thereto.

A method for dissolving or dispersing the inorganic particles and the organic compound in water is not particularly limited as long as the inorganic particles are dispersed, and the organic compound is dissolved or dispersed. For example, a dispersion method in which a medium stirring-type dispersion device in which medium particles are stirred at a high speed such as a planetary mill, a vibratory ball mill, a beads mill, a paint shaker, or an attritor is used is preferred.

During the dissolution or dispersion, it is preferable to disperse the inorganic particles in a primary particle form, then, add the organic compound thereto, and stirring the components so as to be dissolved. In such a case, the surfaces of the primary particles of the inorganic particles are coated with the organic compound, and consequently, carbon derived from the organic compound is uniformly interposed between the primary particles of the inorganic particles.

When the template substance that does not remain as the carbonaceous film Is mixed in during the preparation of the slurry, it is possible to realize a desired micropore diameter distribution in the electrode material. In addition. It is also possible to impart a desired micropore diameter distribution to the electrode material by appropriately using a substance (polyether or the like) including a large amount of oxygen in the structure of the carbon source organic substance or by thermally treating the components in an atmosphere including a small amount of oxygen during the thermal treatment.

Next, the slurry is sprayed and dried in a high-temperature atmosphere, for example, in the alt at a temperature in a range of 70° C. to 250° C.

Next, the dried substance is calcinated in a non-oxidative atmosphere at a calcination temperature in a range of 500° C. to 1000° C., preferably in a range of 600° C. to 900° C., for a calcination duration in a range of 0.1 hours to 40 hours.

When the calcination temperature is 500° C. or more, the organic compound included in the dried substance obtained by drying the slurry is sufficiently decomposed and reacted, and it Is possible to sufficiently carbonize the organic compound. As a result, it is possible to suppress generation of a decomposed substance of the organic compound having a high resistance in the obtained electrode material. When the calcination temperature is 1000° C. or less, it is possible to suppress the composition of the inorganic particle being deviated due to evaporation of Li in the inorganic particles, and the grain growth of the inorganic particles is suppressed. As a result, it is possible to suppress the discharge capacity being decreased at a high charge-discharge rate, and sufficient charge and discharge rate performance can be realized.

The non-oxidative atmosphere is preferably an inert atmosphere such as nitrogen (N₂) or argon (Ar), and, in a case in which it is necessary to further suppress oxidation, a reducing atmosphere including approximately several percent by volume of a reducing gas such as hydrogen (H₂) is preferred. In addition, for the purpose of realizing a desired micropore diameter distribution in the electrode material, a burnable or flammable gas such as oxygen (O₂) may be introduced into the inert atmosphere. In this case, the concentration of the burnable or flammable gas in the inert atmosphere is preferably in a range of 20 ppm to 5000 ppm and more preferably in a range of 50 ppm to 1000 ppm. When the concentration of the burnable or flammable gas in the inert atmosphere is in a range of 20 ppm to 5000 ppm, it is possible to form micropores in the carbonaceous film so that the electrode material has at least one peak of the micropore diameter distribution in a range of 0.4 nm to 5.0 nm.

In the calcination step, the micropore diameter distribution in the obtained electrode material can be controlled by appropriately adjusting the conditions for calcinating the dried substance of the slurry, for example, a temperature-rise rate, a maximum holding temperature, and a holding duration.

In such a case, the surfaces of the primary particles of the inorganic particles are coated with carbon generated from thermal decomposition of the organic compound in the dried substance, and thus an electrode material made of secondary particles in which carbon is interposed among the primary particles of the inorganic particles is obtained.

### Electrode for Lithium-ion Rechargeable Battery

An electrode for a lithium-ion rechargeable battery of the present invention (hereinafter, simply referred to as the electrode) includes the electrode material of the present invention.

In order to produce the electrode of the present embodiment, for example, the electrode material, a binding agent made of a binder resin, and a solvent are mixed together, thereby preparing a paint for forming the electrode or a paste for forming the electrode, fit this time, an auxiliary conductive agent such as carbon black may be added thereto as necessary.

As the binding agent, that is, a binder resin, for example, a polytetrafluoroethylene (PTFE) resin, a polyvinylidene fluoride (PVdF) resin, fluorine rubber, or the like is preferably used.

The blending amount of the binder resin relative to the electrode material is not particularly limited and is, for example, in a range of 1 part by mass to 30 parts by mass and preferably in a range of 3 parts by mass to 20 parts by mass with respect to 100 parts by mass of the electrode material.

Examples of the solvent used for the paint for forming the electrode or the paste for forming the electrode include water; alcohols such as methanol, ethanol, 3-propanol, 2-propanol (isopropyl alcohol: IPA), butanol, pentanol, hexanol, octanol, and diacetone alcohol; esters such as ethyl acetate, butyl acetate, ethyl lactate, propylene glycol monomethyl ether acetate, propylene glycol monoethyl ether acetate, and γ-butyrolactone; ethers such as diethyl ether, ethylene glycol mononethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether; ketones such as acetone, methyl ethyl ketone (MEK), methyl isobutyl ketone (MIBK), acetyl acetone, and cyclohexanone; amides such as dimethyl formamide, N,N-dimethylacetoacetamide, and N-methyl pyrrolidone; glycols such is ethylene glycol, diethylene glycol, and propylene glycol; and the like. These solvents may be singly used or in a mixture form of two or more solvents.

Next, the paint for forming the electrode or the paste for forming the electrode is applied to one surface of a metal foil and then is dried, thereby obtaining a metal foil including a coated film made of a mixture of the electrode material and the binder resin on one surface.

Next, the coated film is pressed under pressure and dried, thereby producing a current collector (electrode) including an electrode material layer on one surface of the metal foil.

In the above-described manner, an electrode capable of improving electron conductivity can be produced without impairing the lithium ion conductivity of the present embodiment.

Lithium-ion Rechargeable Battery

A lithium-ion rechargeable battery of the present invention includes the electrode of the present invention as a cathode.

In the lithium-ion rechargeable battery, when the electrode of the present invention is used as the cathode, it is possible to suppress the internal resistance at a low level, and consequently, it is possible to provide a lithium-ion rechargeable battery that can be charged and discharged at a high speed without any concerns of significant voltage drop.

### EXAMPLES

Hereinafter, the present invention will be described in detail using examples, but the present invention is not limited to the following examples.

Specimens of Examples 1 to 6 and Comparative Example 1 were produced in the following manner.

### Example 1

Production of Electrode Material

Lithium acetate (LiCH₃COO) (4 mol), iron (II) sulfate (FeSO₄) (2 mol), and phosphoric acid (H₃PO₄) (2 mol) were added to water (2 L) and were mixed together so that the total amount reached 4 L, thereby preparing a homogeneous slurry-form mixture.

Next, the mixture was stored in a pressure-resistant airtight container having a capacity of 8 L and was hydrothermally synthesized at 200° C. for 16 hours.

Next, the obtained precipitate was washed with water, thereby obtaining a cake-form electrode active material (inorganic particles).

Next, the electrode active material (100 g, solid content-equivalent) and a polyvinyl alcohol aqueous solution obtained by dissolving a polyoxyethylene sorbitan ester including a large amount of oxygen in the structure (5 g) as an organic compound in water (100 g) were mixed together, thereby producing a slurry. A dispersion treatment was carried cut on the slurry using a two-fluid wet-type jet crusher.

Next, the slurry on which the dispersion treatment had been carried out was sprayed and dried in the atmosphere at 180° C., and the obtained dried substance was thermally treated at 700° C. for three hours in a nitrogen atmosphere not including oxygen, thereby obtaining a specimen of Example 1. In the specimen of Example 1, micropores were formed in the carbonaceous film by desorbing oxygen from functional groups in the carbonaceous film during the thermal treatment.

### Example 2

Sucrose (7 g) was used as a carbon source, a wax aqueous emulsion (1 g, solid content) was mixed therewith as a template, the mixture was held at 420° C. for two hours while the temperature was increased during a thermal treatment, and a wax was desorbed. After that, a thermal treatment was carried out at 700° C. for three hours. A specimen of Example 2 was produced in the same manner as in Example 1 except for what has been described above. In the specimen of Example 2, micropores were formed in the carbonaceous film using a template substance.

### Example 3

A substance obtained by refluxing an aqueous solution obtained by mixing polypropylene glycol and polyacrylic acid in a weight ratio of 1:2 at a boiling point for 24 hours, then, heating the aqueous solution in a vacuum at 120° C., removing water, and then dissolving the aqueous solution in water again was used as a carbon source. A specimen of Example 3 was produced in the same manner as in Example 1 except for what has been described above. Meanwhile, the presence of an ester bond In the carbon source used was confirmed by means of FT-IR. In the specimen of Example 3, micropores were formed in the carbonaceous film by generating a carbonaceous film precursor including a large amount of oxygen in the structure by means of dehydration baaed on a condensation reaction during an ester reaction.

### Example 4

A specimen of Example 4 was produced in the same manner as in Example 3 except for the fact that PVA was used instead of polyacrylic acid. In the specimen of Example 4, micropores were formed in the carbonaceous film by generating a carbonaceous film precursor including a large amount of oxygen in the structure by means of dehydration based on a condensation reaction during an ether reaction.

### Example 5

Manganese (II) sulfate (MnSO₄) was used instead of iron (II) sulfate (FeSO₄), and a polyoxyethylene sorbitan ester (5 g) was used as a carbon source together with a LiOH-Fe (COO)₂—NH₄H₂PO₄ carbonization catalyst. In addition, a thermal treatment was carried out at 700° C. for three hours in a nitrogen atmosphere including 50 ppm of oxygen. A specimen of Example 5 was produced in the same manner as in Example 1 except for what has been described above.

### Example 6

A specimen of Example 6 was produced in the same manner as in Example 2 except for the fact that some of iron (II) sulfate (FeSO₄) was substituted with manganese (II) sulfate (MnSO₄), and the ratio of Fe to Mn was set to 3/7 in the production of the electrode material.

### Comparative Example 1

A specimen of Comparative Example 1 was produced in the same manner as in Example 3 except for the fact that dehydration by means of a condensation reaction was not caused by adding only polypropylene glycol as a carbon source. In the specimen of Comparative Example 1, a step of forming micropores in the carbonaceous film was not carried out.

### Evaluation of Electrode Material

The following evaluations were carried out on the specimens of Examples 1 to 6 and Comparative Example 1.

(1) Amount of Carbon

The amounts of carbon in the specimens of Examples 1 to 6 and Comparative Example 1 were measured using a carbon analyzer (manufactured by Horiba Ltd., Product Mo.: EMIA2000).

(2) Coating Ratio with Carbonaceous Film

In the specimens of Examples 1 to 6 and Comparative Example 1, the carbonaceous films in seven electrode active materials were observed using a transmission electron microscope (TEM) (manufactured by Hitachi High-Technologies Corporation, product No.: RD2700) and an energy-dispersive X-ray spectrometer (EDX) mounted therein. In addition, the proportions of a portion covered with the carbonaceous film in the surface of an agglomerate were computed, and the average value thereof was used as the coating ratio.

(3) Specific Surface Area

The specific surface area of the electrode active material in the specimen of each of Examples 1 to 6 and Comparative Example 1 was measured using a specific surface area meter (manufactured by Mountech Co., Ltd., product No.: Macsorb1200).

(4) Micropore Diameter Distribution in Carbonaceous Film

The micropore diameter distribution in the specimen of each of Examples 1 to 6 and Comparative Example 1 was measured using a nitrogen adsorption amount measurement instrument (manufactured by MircotracBEL Corp., product No.: BELSORP-max). Meanwhile, only peaks which were as tall as 5% or more of the height of the maximum peak were counted as peaks. In such a manner, it was prevented to count peaks generated due to fluctuation of measurement values as peaks.

(5) Charge and Discharge Capacity and Activation Energy

The charge and discharge capacity and the activation energy were evaluated using lithium-ion rechargeable batteries respectively produced using the specimens of Examples 1 to 6 and Comparative Example 1.

### Production of Lithium-ion Battery

The specimen of each of Examples 1 to 6 and Comparative Example 1 as an electrode material, polyvinylidene fluoride (PVdF) as a binder, and acetylene black (AB) as a conductive auxiliary agent were mixed together so that the mass ratio therebetween reached 90:5:5, and furthermore, fluidity was imparted by adding N-methyl-2-pyrrolidone (NMP) as a solvent, thereby producing a slurry.

Next, the slurry was applied and dried on a 15 μm-thick aluminum (Al) foil. After that, the slurry was pressed under a pressure of 600 kgf/cm², thereby producing a cathode for a lithium-ion rechargeable battery having an electrode area of 2 square centimeters and an electrode density of 1.6 g/cc.

The above-described cathode and a lithium metal as an anode were disposed in a coin cell container having a diameter of 2 cm and a thickness of 3.2 mm, and a 25 μm-thick separator made of porous polypropylene was disposed between the cathode and the anode, thereby producing a member for the battery.

Meanwhile, ethylene carbonate and diethyl carbonate were mixed together in a mass ratio of 1:1, and furthermore, a LiPFe₆ solution (1 M) was added thereto, thereby producing an electrolyte solution having lithium ion conductivity.

Next, the member for the battery was immersed in the electrolyte solution, thereby producing a lithium-ion rechargeable battery.

### Charge and Discharge Capacity

The 3C charge and discharge capacity of the produced lithium-ion rechargeable battery was computed using a charge and discharge tester (manufactured by Hokuto Denko Corp., product No.: HJ100SM8A).

### Activation Energy

The impedance of the produced lithium-ion rechargeable battery was measured using an electrochemical measurement instrument (manufactured by Princeton Applied Research, product No.: VersaSTAT4). The impedance was measured at a frequency in a range of 1 MHz to 0.1 mHz, and a semicircular arc appearing at a frequency of 100 Hz or leas was used as the charge migration resistance of lithium ions occurring in the interface between a carbon layer and an active material. The impedance was measured at 30° C., 35° C., 40° C., 45° C., 50° C., and 55° C. When the logarithm of the impedance and the inverse number (1/T) of the temperature at which the impedance was measured were plotted, a straight line was obtained, and thus it was found that the Arrhenius behaviors appeared, and the activation energy was computed from the slope of the straight line.

TABLE 1

| | Amount | Coating ratio | Specific | Micropore | Charge and | |
|---|---|---|---|---|---|---|
| | of | with | surface | diameter | discharge | Activation |
| | carbon | carbonaceous | area | peak | capacity (3C) | energy |
| | Wt % | film % | m²/g | nm | mAh/g | kJ/mol |
| Example 1 | 1.3 | 90 | 17 | 0.75 | 127 | 55 |
| Example 2 | 2.6 | 88 | 15 | 0.92, 4.1 | 139 | 61 |
| Example 3 | 1 | 75 | 18 | 0.71, 0.82 | 144 | 55 |
| Example 4 | 1.2 | 90 | 14 | 0.92 | 124 | 49 |
| Example 5 | 1.5 | 74 | 22 | 0.6, 0.9, 2.2 | 133 | 56 |
| Example 6 | 1.5 | 78 | 18 | 1.2 | 121 | 62 |
| Comparative | 1 | 77 | 15 | 105 | 108 | 88 |
| Example 1 | | | | | | |

As a result of evaluating Comparative Example 1, it was confirmed that a micropore diameter peak was present at 105 nm, and there were no peaks of the micropore diameter distribution in a range of 0.4 nm to 5.0 nm.

When Examples 1 to 6 and Comparative Example 1 were compared with each other, it was found that, when the electrode material had at least one peak of the micropore diameter distribution in a range of 0.4 nm to 5.0 nm, the activation energy for a migration reaction of lithium ions occurring at the interface between the inorganic particle and the carbonaceous film became small. Therefore, it was found that, when the electrode material had at least one peak of the micropore diameter distribution in a range of 0.4 nm to 5.0 nm, lithium ion conductivity became favorable even when the surface of the electrode active material (inorganic particles) was coated with the carbonaceous film.

1. An electrode material for a lithium-ion rechargeable battery comprising:
inorganic particles represented by General Formula LiFeₓMn_{1-x-y}M_{y}PO₄ (0.05≦x≦1.0, 0≦y≦0.14; here, M represents at least one element selected from the group consisting of Mg, Ca, Co, Sr, Ba, Ti, Zn, B, Al, Ga, In, Si, Ge, and rare earth elements); and
a carbonaceous film coating surfaces of the inorganic particles and having micropores,
wherein the electrode material has al least one peak of a micropore diameter distribution in a range of 0.4 nm to 5.0 nm, measured using a nitrogen adsorption amount measurement instrument (manufactured by MircotracBEL Corp., product No.: BELSORP.max)

2. The electrode material for a lithium-ion rechargeable battery according to claim 1,
wherein the electrode material has two or more peaks of a micropore diameter distribution in a range of 0.4 nm to 5.0 nm.

3. The electrode material for a lithium-ion rechargeable battery according to claim 1,
wherein activation energy for a migration reaction of lithium ions in an interface between the inorganic particle and the carbonaceous film is 70 kJ/mol or less.

4. The electrode material for a lithium-ion rechargeable battery according to claim 1,
wherein the carbonaceous film coats 50% or more of the surfaces of the inorganic particles.

5. An electrode for a lithium-ion rechargeable battery comprising:
the electrode material for a lithium-ion rechargeable battery according to claim 1.

6. A lithium-ion rechargeable battery comprising;
a cathode; an anode; and a non-aqueous electrolyte,
wherein the lithium-ion rechargeable battery comprises the electrode for a lithium-ion rechargeable battery according to claim 5 as the cathode.
